(19) United States
(12) Patent Application Publication
(10) Pub. No.: US 2002/0156778 A1
(43) Pub. Date: Oct. 24, 2002

(54) Phrase-based text searching

(76) Inventor: Douglas H. Beeferman, W. Concord, MA (US)

Correspondence Address: PAUL A. PYSHER, Fish & Richardson P.C., 225 Franklin Street, Boston, MA, 02110-2804, US

(21) Appl. No.: 09/840,851

(22) Filed: Apr. 24, 2001

(51) Int. Cl. G06F 7/00

(52) U.S. Cl. 707/5

(57) ABSTRACT

The computer-implemented process includes establishing a database containing data corresponding to a probability that words occur together in text, receiving a phrase comprised of the words, retrieving the data for the words from the database in response to receiving the phrase, and determining, based on the data, whether to perform a text search for the phrase as a whole or for the words individually.

### TECHNICAL FIELD

This invention relates generally to phrase-based text searching and, more particularly, to determining whether to perform a text search for a phrase as a whole or for individual words in the phrase.

### BACKGROUND

Internet search engines operate by searching the Internet for input keywords. Delineating the keywords using operators, such as quotation marks, causes some search engines to search the Internet for the entire phrase between the operators. For example, inputting “hot dog”0 into a search engine will return a list of documents that contain the word “hot” immediately followed by the word “dog”. Omitting operators may cause the search engine to return a list of documents that contain the words “hot” and/or “dog”, but not necessarily the phrase “hot dog”. This can lead to poor search results.

### SUMMARY

In general, in one aspect, the invention is directed to a computer-implemented process which includes establishing a database containing data corresponding to a probability that words occur together in text, receiving a phrase comprised of the words, retrieving the data for the words from the database in response to receiving the phrase, and determining, based on the data, whether to perform a text search for the phrase as a whole or for the words individually. This aspect of the invention may include one or more of the features set forth below.

The process of establishing the database may include searching through text from one or more documents and determining a metric indicative of the probability that words will occur together in text of one or more documents. The metric may be determined based on a probability that the words will occur together and a probability that the words will occur individually. The metric may be a ratio of the probability that the words will occur together and the probability that the words will occur individually. The one or more documents may include World Wide Web pages.

The process of determining how to perform a text search may include comparing data to a predetermined threshold, performing the text search for the phrase as a whole if the data exceeds the predetermined threshold or performing the text search for the words individually if the data does not exceed the predetermined threshold. The text search may be performed on another database. The other database may include the Internet. The words may include two or more words in series.

If it is determined to perform the text search for the phrase as a whole, the process performs the text search for the phrase as a whole. The text search may be performed for the words individually after performing the text search for the phrase as a whole. If it is determined to perform the text search for the words individually, the process performs the text search for the words individually.

The process may include issuing a message, based on a result of the determination, asking whether to perform the text search for the phrase as a whole and performing the text search for the phrase as a whole or for the words individually based on a response to the message. The one or more documents may include a past query log.

Other features and advantages of the invention will become apparent from the following description, including the claims and drawings.

### BRIEF DESCRIPTION OF THE DRAWINGS

FIG. 1 is a block diagram of a network.

FIG. 2 is a flowchart of a process for performing text searches over the network of FIG. 1.

FIG. 3 is a flowchart of an alternative process for performing text searches over the network of FIG. 1.

FIG. 4 is a flowchart of an alternative process for performing text searches over the network of FIG. 1.

### DESCRIPTION

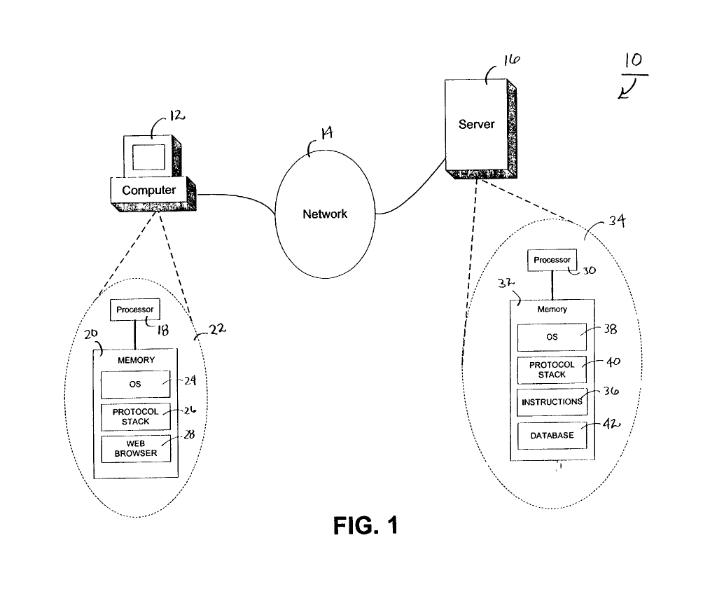

FIG. 1 shows a system 10. System 10 includes a computer 12, such as a personal computer (PC) . Computer 12 is connected to a network 14, such as the Internet, that runs TCP/IP (Transmission Control Protocol/Internet Protocol) or another suitable protocol. Connections may be via Ethernet, wireless link, telephone line, or the like. Network 14 contains a server 16, which may be a mainframe computer, a PC, or any other type of processing device.

Computer 12 contains a processor 18 and a memory 20 (see view 22). Memory 20 stores an operating system (“OS”) 24 such as Windows98®, a TCP/IP protocol stack 26 for communicating over network 14, and a Web browser 28 such as Internet Explorer® or Netscape Navigator®, for accessing Web sites and pages hosted by devices on network 14.

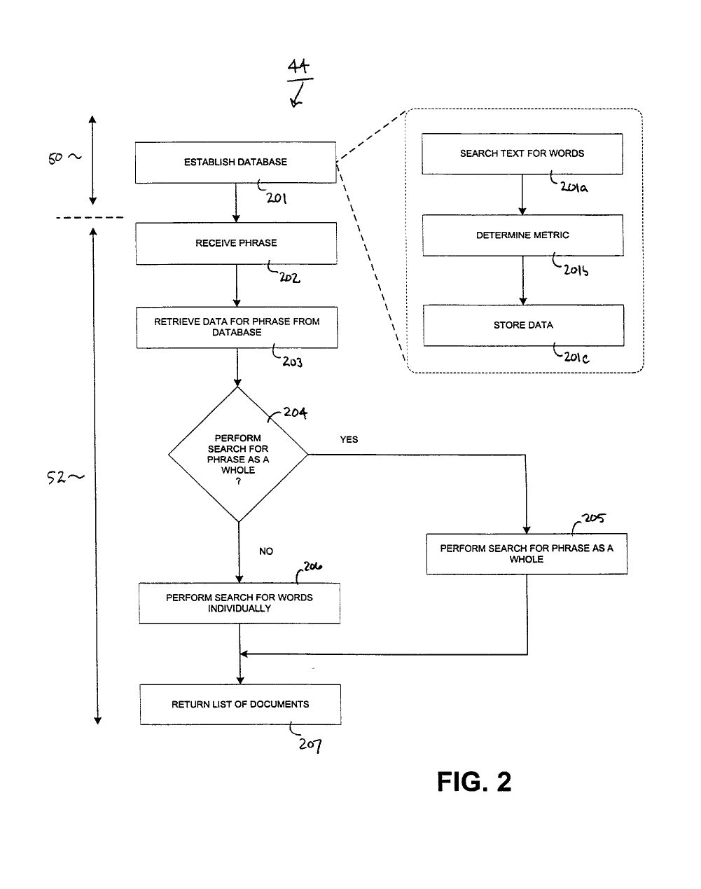

Server 16 contains a processor 30 and a memory 32 (see view 34). Memory 32 stores machine-executable instructions 36, OS 38, TCP/IP protocol stack 40, and database 42 relating to users' Web searches. Database 42 is described below. Instructions 36 may be part of an Internet search engine (or not), and are executed by processor 30 to perform processes 44, 46 and 48 below. That is, a user at computer 12 uses Web browser 28 to access server 16, which, in response to a user-input phrase, executes instructions 36 to perform the processes described in FIGS. 2 to 4.

Referring to FIG. 2, process 44 is shown for performing phrase-based Internet searches. In this embodiment, process 44 contains two phases: a training phase 50 and a run-time phase 52. Training phase 50 may be executed one or more times prior to the first execution of run-time phase 52 and then at predetermined periods of time thereafter, or as desired. Run-time phase 52 is executed each time a user searches the Internet (or whatever database process 44 is being used to search).

During training phase 50, process 44 establishes (201) a database 42 that contains data corresponding to a probability that two or more words will occur together in text. What is meant by “together” in this context is that the words are in series, adjacent, or within a number of words of each other. Process 44 establishes (201) the database by searching (201a) through text from one or more documents, such as World Wide Web pages, and determining (201b) a metric indicative of the likelihood that the words will occur together (versus individually) in the text. Process 44 may search through any number of documents, but preferably uses a statistically-relevant sampling.

By way of the example described in the Background section above, process 44 searches through World Wide Web pages to determine the probability that the words “hot” and “dog” will occur together in text. Process 44 also searches through the same documents to determine the probability that the words “hot” and “dog” will occur individually, i.e., simply that the words occur, either together or alone, in the documents.

Process 44 determines a metric that is based on the probability that the words will occur together and the probability that the words will occur individually. In this embodiment, the metric is a ratio of the probability that the words will occur together to the probability that the words will occur individually. That is, in the above example, the probability is the ratio of the probability of the phrase “hot dog” (i.e., the words occurring together) occurring in the sampled documents, to the probability of the words “hot” and “dog” occurring individually, i.e., not together in the sampled documents.

The metric can be determined mathematically from

P(w₁ w₂ w₃ . . . wₙ)/P(w₁)P(w₂) . . . P(wₙ), (1)

where P(w₁ w₂ w₃ . . . wₙ) is the probability that words w₁ w₂ w₃ . . . wₙ will occur together in the documents searched, that is, as a phrase, and P(wₙ) is the probability that the words will occur individually in the documents searched. Equation (1) above is substantially equivalent to

P(w₁)P(w₂|w₁)P(w₃|w₂) . . . P(wₙ|wₙ₋₁)/P(w₁)P(w₂) . . . P(wₙ), (2)

where P(wₙ|wₙ₋₁) is the probability that word wₙ will precede word wₙ₋₁ in the text. By canceling terms, equation (2) simplifies to

P(w₂|w₁)P(w₃|w₂) . . . P(wₙ|wₙ₋₁)/P(w₂) . . . P(wₙ), (3)

which is used by process 44 to determine the metric for the phrase P(w₁ w₂ w₃ . . . wₙ).

Process 44 stores (201c), in database 42, the metric derived from equation (3) for each of plural predetermined phrases. Process 44 may re-establish and/or update this database as desired. The more phrases that are incorporated into database 42, the more accurate the search results will be, as is evidenced below.

During run-time phase 52, process 44 receives (202) a phrase comprised of two or more words. For illustration's sake, we will use the bigram (i.e., two word) model. This means that database 42 contains metric data for two-word phrases and that a two-word phrase has been input to process 44, e.g., via the graphical user interface (World Wide Web page) of an Internet search engine

Process 44 searches through database 42 to determine if the input phrase matches a phrase in database 42. If there is a match, process 44 retrieves (203) the metric data for that phrase from database 42. Process 44 determines (204), based on the metric data, whether to perform a text search for the phrase as a whole (e.g., for “hot dog”) or for the words individually (e.g., for “hot” and “dog”).

Process 44 makes the determination (204) by comparing the metric data for the phrase to a predetermined threshold. If the metric data exceeds the predetermined threshold, process 44 performs (205) the text search for the phrase as a whole. In this embodiment, the text search is of the Internet; however, it may be of any database. If the metric data does not exceed the predetermined threshold, process 44 performs (206) the text search for the words individually. The threshold is set beforehand, e.g., in memory 32, to provide a desired tolerance. That is, the metric data for each phrase (the result of equation (3)) is indicative of the likelihood that a user desires to search for an entire phrase as opposed to individual words in that phrase. The threshold is set so that process 44 only searches for phrases with a certain likelihood.

Following searching, process 44 returns (207) a list of documents to the user based on the search results. Typically, the list contains hyperlinks to the documents.

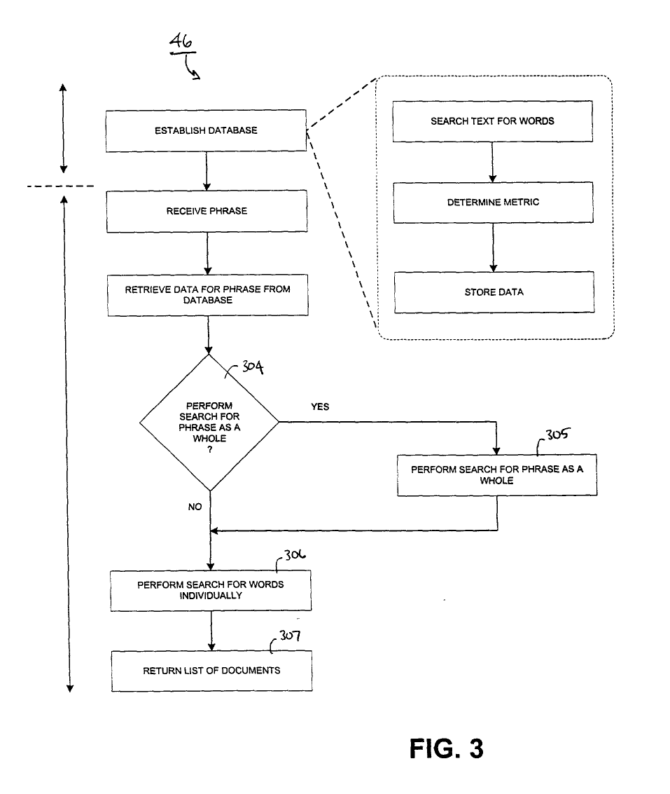

FIG. 3 shows an alternative to process 44. Process 46 of FIG. 3 is identical to process 44 of FIG. 1, with one difference. If process 46 decides (304) to perform a search for the phrase as a whole, process 46 performs (305) the required search and then performs (306) a search for the words individually. Process 46 returns (307) a list of documents containing the phrase as a whole followed, in the list, by documents that contain the words individually. Thus, process 46 gives priority to phrase-based searches, while still searching for the words individually.

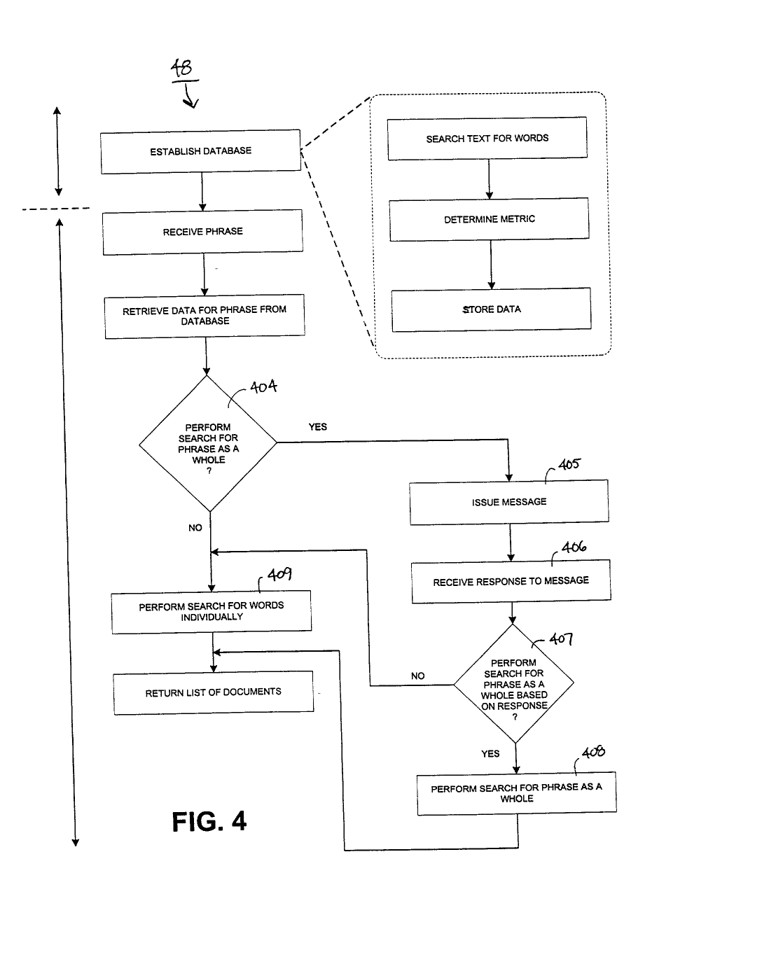

FIG. 4 shows an alternative to processes 44 and 46. Process 48 is identical to process 46, except that process 48 provides the user with an option to select or reject searching for phrases as a whole. In more detail, process 48 determines (404) whether to perform a search for the phrase as a whole or for the words individually. If process 48 decides to perform a search for the phrase as a whole, process 48 issues (405) the user a message asking whether the user would like to search for the phrase as a whole or for the words individually.

Process 48 receives (406) a response to the message from the user. If the response indicates to perform a search for the phrase as a whole (407), process 48 performs (408) the search for the phrase as a whole. If the response indicates to perform a search for the words individually (407), process 48 performs (409) the search for the words individually. The remainder of process 48 is identical to process 44 described above.

It is noted that elements of processes 44, 46, and 48 may be combined to form embodiments not explicitly described herein. For example, the message elements of process 48 may be incorporated into process 46 to provide the user with an option to perform priority searching, such as the searching technique described in process 46.

Processes 44, 46 and 48 are not limited to use with the hardware/software configuration of FIG. 1; they may find applicability in any computing or processing environment. Processes 44, 46 and 48 may be implemented in hardware (e.g., an ASIC {Application-Specific Integrated Circuit} and/or an FPGA {Field Programmable Gate Array}), software, or a combination of hardware and software.

Processes 44, 46 and 48 may be implemented using one or more computer programs executing on programmable computers that each includes a processor, a storage medium readable by the processor (including volatile and non-volatile memory and/or storage elements), at least one input device, and one or more output devices.

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 44, 46 and 48.

Processes 44, 46 and 48 may also be implemented using a computer-readable storage medium, configured with a computer program, where, upon execution, instructions in the computer program cause the computer to operate in accordance with processes 44, 46 and 48.

Processes 44, 46 and 48 are not limited to use with the Internet, and may be used with any type of database. For example, processes 44, 46 and 48 may be used to search past query logs, i.e., stored previous user queries. That is, processes 44, 46 and 48 may store successful user queries in memory and then search those queries to determine if input words should be searched for as a phrase or as individual words. Processes 44, 46 and 48 are not limited to use in a network context or to use with any particular search engine.

Other embodiments not described herein are also within the scope of the following claims.

What is claimed is:

1. A computer-implemented method comprising:
establishing a database containing data corresponding to a probability that words occur together in text;
receiving a phrase comprised of the words;
retrieving the data for the words from the database in response to receiving the phrase; and
determining, based on the data, whether to perform a text search for the phrase as a whole or for the words individually.

2. The method of claim 1, wherein establishing the database comprises:
searching through text from one or more documents; and
determining a metric indicative of the probability that the words will occur together in the text of the one or more documents:

3. The method of claim 2, wherein the metric is determined based on a probability that the words will occur together and a probability that the words will occur individually.

4. The method of claim 3, wherein the metric comprises a ratio of the probability that the words will occur together and the probability that the words will occur individually.

5. The method of claim 2, wherein the one or more documents comprise World Wide Web pages.

6. The method of claim 1, wherein determining comprises:
comparing the data to a predetermined threshold;
performing the text search for the phrase as a whole if the data exceeds the predetermined threshold; and
performing the text search for the words individually if the data does not exceed the predetermined threshold.

7. The method of claim 6, wherein the text search is performed on another database.

8. The method of claim 7, wherein the other database comprises Web databases on the Internet.

9. The method of claim 1, wherein the words comprise two or more words in series.

10. The method of claim 1, wherein, if it is determined to perform the text search for the phrase as a whole, the method further comprises:
performing the text search for the phrase as a whole.

11. The method of 10, further comprising:
performing the text search for the words individually after performing the text search for the phrase as a whole.

12. The method of claim 1, wherein, if it is determined to perform the text search for the words individually, the method further comprises:
performing the text search for the words individually.

13. The method of claim 1, further comprising:
issuing a message, based on a result of the determining, asking whether to perform the text search for the phrase as a whole; and
performing the text search for the phrase as a whole or for the words individually based on a response to the message.

14. The method of claim 1, wherein the one or more documents comprise a past query log.

15. A computer program stored on a computer-readable medium, the computer program comprising instructions that cause a machine to:
establish a database containing data corresponding to a probability that words occur together in text;
receive a phrase comprised of the words;
retrieve the data for the words from the database in response to receiving the phrase; and
determine, based on the data, whether to perform a text search for the phrase as a whole or for the words individually.

16. The computer program of claim 15, wherein establishing the database comprises:
searching through text from one or more documents; and
determining a metric indicative of the probability that the words will occur together in the text of the one or more documents.

17. The computer program of claim 16, wherein the metric is determined based on a probability that the words will occur together and a probability that the words will occur individually.

18. The computer program of claim 17, wherein the metric comprises a ratio of the probability that the words will occur together and the probability that the words will occur individually.

19. The computer program of claim 16, wherein the one or more documents comprise World Wide Web pages.

20. The computer program of claim 15, wherein determining comprises:
comparing the data to a predetermined threshold;
performing the text search for the phrase as a whole if the data exceeds the predetermined threshold; and
performing the text search for the words individually if the data does not exceed the predetermined threshold.

21. The computer program of claim 20, wherein the text search is performed on another database.

22. The computer program of claim 21, wherein the other database comprises Web databases on the Internet.

23. The computer program of claim 15, wherein the words comprise two or more words in series.

24. The computer program of claim 15, further comprising:
instructions to perform the text search for the phrase as a whole if it is determined to perform the text search for the phrase as a whole.

25. The computer program of 24, further comprising:
instructions to perform the text search for the words individually after performing the text search for the phrase as a whole.

26. The computer program of claim 15, further comprising instructions to perform the text search for the words individually if it is determined to perform the text search for the words individually.

27. The computer program of claim 15, further comprising instructions to:
issue a message, based on a result of the determining, asking whether to perform the text search for the phrase as a whole; and
perform the text search for the phrase as a whole or for the words individually based on a response to the message.

28. The computer program of claim 15, wherein the one or more documents comprise a past query log.

29. An apparatus comprising:
a memory that stores executable instructions; and
a processor that executes the instructions to:
establish a database containing data corresponding to a probability that words occur together in text;
receive a phrase comprised of the words;
retrieve the data for the words from the database in response to receiving the phrase; and
determine, based on the data, whether to perform a text search for the phrase as a whole or for the words individually.

30. The apparatus of claim 29, wherein establishing the database comprises:
searching through text from one or more documents; and
determining a metric indicative of the probability that the words will occur together in the text of the one or more documents.

31. The apparatus of claim 30, wherein the metric is determined based on a probability that the words will occur together and a probability that the words will occur individually.

32. The apparatus of claim 31, wherein the metric comprises a ratio of the probability that the words will occur together and the probability that the words will occur individually.

33. The apparatus of claim 30, wherein the one or more documents comprise World Wide Web pages.

34. The apparatus of claim 29, wherein determining comprises:
comparing the data to a predetermined threshold;
performing the text search for the phrase as a whole if the data exceeds the predetermined threshold; and
performing the text search for the words individually if the data does not exceed the predetermined threshold.

35. The apparatus of claim 34, wherein the text search is performed on another database.

36. The apparatus of claim 35, wherein the other database comprises Web databases on the Internet.

37. The apparatus of claim 29, wherein the words comprise two or more words in series.

38. The apparatus of claim 29, wherein the processor executes instruction to perform the text search for the phrase as a whole if it is determined to perform the text search for the phrase as a whole.

39. The apparatus of 38, wherein the processor executes instruction to perform the text search for the words individually after performing the text search for the phrase as a whole.

40. The apparatus of claim 29, wherein the processor executes instruction to perform the text search for the words individually if it is determined to perform the text search for the words individually.

41. The apparatus of claim 29, wherein the processor executes instructions to:
issue a message, based on a result of the determining, asking whether to perform the text search for the phrase as a whole; and
perform the text search for the phrase as a whole or for the words individually based on a response to the message.

42. The apparatus of claim 29, wherein the one or more documents comprise a past query log.
